(19) United States
(12) Patent Application Publication
(10) Pub. No.: US 2023/0363428 A1
(43) Pub. Date: Nov. 16, 2023

(54) DISH FROM FERMENTED MIXTURES AND ITS PREPARATION

(71) Applicant: Johannes Biener, Graz (AT)

(72) Inventor: Johannes Biener, Graz (AT)

(21) Appl. No.: 18/027,010

(22) PCT Filed: Sep. 17, 2021
(86) PCT No.: PCT/EP2021/075645

§ 371 Date: Mar. 17, 2023

(30) Foreign Application Priority Data
Sep. 18, 2020 (AT) A 60288/2020
Mar. 4, 2021 (EP) 21160677.7

(51) Int. Cl. A23L 7/104; A23L 11/00; A23L 5/10

(52) U.S. Cl. CPC A23L 7/104; A23L 11/05; A23L 5/10

(57) ABSTRACT

The present invention relates to a method for producing a mushy mass having preferably high porosity and/or elasticity, using (pseudo) cereals, pulses and/or oilseeds. The mushy mass is suitable for producing a very porous, very elastic, non-sticky dish. The present invention therefore also relates to dishes that can be produced by way of methods that are particularly suitable for people with specific health needs.

The present invention relates to a method for producing a mushy mass having preferably high porosity and/or elasticity, using (pseudo) cereals, pulses and/or oilseeds. The mushy mass is suitable for producing a very porous, very elastic, non-sticky dish. The present invention therefore also relates to dishes that can be produced by way of methods that are particularly suitable for people with specific health needs.

Vegetarian and vegan dishes are increasingly in demand in the European market as well. Especially in the Asian region, many such dishes are part of traditional cuisine, for example idli, a fermented batter dish based on black lentils and rice. In addition to plant-based, carbohydrate-rich and protein-rich ingredients, in this case generally spices and different vegetables are also used in order to also enhance the vitamin content of the dishes, in addition to the taste. While traditional Asian cuisine usually draws on an undefined or poorly defined acidifying culture when fermenting the batter, which culture is generally not added specially but rather develops spontaneously in the dough, defined methods also exist for carrying out acidifying and gassing processes during the fermentation of such batters (WO 2017/140796; CN 108029944).

The production processes known hitherto for such vegetarian and vegan batter dishes are associated with various disadvantages. For example, during fermentation using spontaneously formed acidifying cultures, potentially pathogenic microorganisms such as Streptococcus faecalis can also occur. In the fermentation technique carried out hitherto, using undefined acidifying cultures, dishes are produces which have inadequate or at least only somewhat satisfactory results for marketing in Europe, with respect to porosity, elasticity and surface structure. It is also barely possible or impossible to carry out industrial manufacture, and/or it results in unsatisfactory products. In addition, the glycemic index is unsatisfactory, specifically for diabetics, since the structure and composition of the carbohydrates contained in the end product and the type of fibers, result in a very rapid increase in the blood sugar level after eating, followed by a rapid drop thereof.

The present invention, as described in the following and defined in the claims, solves the problem existing in the prior art by providing the inventive method for producing a mushy mass, and providing dishes which are or can be produced by this method.

The present invention relates to a method for producing a mushy mass, comprising
(a) allowing cereals, pseudo cereals, pulses and/or oilseeds to swell but not to germinate;
(b) wet grinding of the swelled cereals, pseudo cereals, the pulses and/or the oilseeds to form a mushy mass;
(c) first fermenting of the mushy mass using acid-forming microorganisms; and
(d) second fermenting of the already fermented mushy mass using 002-forming microorganisms.

First and second fermenting preferably takes place separate in time and/or space.

Preferably no intermediate step takes place between the first and second fermenting, i.e., after the first fermenting or before the second fermenting. Preferably, the consistency of the mushy mass is substantially maintained between the first and second fermentation, in particular, the consistency of the mushy mass is maintained between the first and second fermentation. Preferably no liquid-binding foodstuff, such as ground products of cereals, pseudo cereals, legumes, oilseeds or nuts (including real and fake nuts), is added between the first and second fermentation.

That is to say that preferably no cereals, pseudo cereals, pulses and/or oilseed, in particular cereals or pseudo cereals or cereals and pseudo cereals in the form of a ground product, e.g., in ground form or as flour, are added between the first and second fermenting.

Likewise, after the second fermenting and before the cooking, the consistency of the mushy mass is substantially maintained, in particular, after the second fermentation and before the cooking, the consistency of the mushy mass is maintained. Preferably no liquid-binding foodstuff, such as ground products of cereals, pseudo cereals, legumes, oilseeds or nuts (including real and fake nuts), is added between the first and second fermentation and before the cooking. That is to say that preferably no cereals, pseudo cereals, pulses and/or oilseed in the form of a ground product, in particular cereals or pseudo cereals or cereals and pseudo cereals in the form of a ground product, e.g., in ground form or as flour, are added after the second fermenting and/or before the cooking.

The method according to the invention can furthermore preferably comprise (e) filling or transferring the once-fermented mass into another vessel.

However, said step (c′) does not necessarily have to take place. Specifically, it is also possible to have the first and second fermentation, as described herein, take place separated from one another in time. This is possible because the first and second ferment, as described herein, are different in terms of the microorganisms. The microorganisms in the first fermentation bring about acid formation. The microorganisms in the second fermentation bring about gas formation. That is to say that the second fermenting preferably takes place in a separated in time from the first fermenting, specifically after the first fermenting. The step (c′) is nonetheless a preferred step of the method according to the invention.

The method according to the invention can comprise the following further step: (e) optionally mixing the twice-fermented mushy mass(es).

As was surprisingly found in the context of the present invention, a mushy mass or (batter) dish is produced by using the method according to the invention, which mass or dish is preferably characterized by a high starch portion, high portion of prebiotics and fiber, as well as vitamins (in particular vitamin B complexes and omega 3 fatty acids). In this case, a substantial component of the invention is the multi-stage, preferably two-stage, fermentation process (separation of acid and gas formation during the fermentation), which results in a mushy mass or (batter) dish having preferably high porosity and/or elasticity. In contrast to production methods in the prior art, on account of the separation of the acid and gas formation in the multi-stage, preferably two-stage, fermentation, the mushy mass can be portioned before the cooking process, such that uniform amounts of the fermented mushy mass, for a product to be cooked, can undergo cooking. Uniform products thus result. This is not possible in the prior art. There, for example mushy masses undergo fermentation in which acid and gas is formed simultaneously. If said fermented mushy mass is intended to be portioned, then limits are reached in particular in industrial, automatic portioning because the gassed, mushy mass cannot be uniformly portioned on account of the gas introduced therein, and in addition in the process the gas introduced into the mushy mass escapes during the portioning process. There are thus non-uniformly distributed mushy masses, if these can even be portioned at all, and furthermore mushy masses which contain no gas or no longer contain sufficient gas, such that they do not rise, i.e., remain flat, during the cooking process. Thus, no products are obtained which have a desired elasticity and/or porosity. The present invention can overcome this problem by means of the multi-stage, preferably two-stage, fermentation, as described herein.

The method according to the invention is preferably an industrial-scale method. “Industrial-scale” means that the steps of the method according to the invention can be carried out in a mechanically automated manner. “Industrial-scale” also means that at least 50 kg, 100 kg, 200 kg, 500 kg, 1000 kg, 2000 kg, 5000 kg, 10000 kg mushy mass, as described herein, can be processed into dishes per working day by means of the method according to the invention. A working day means 12 to 24 hours, preferably 12 hours.

In connection with the present invention, “allow to swell” is the soaking of cereals, pseudo cereals, pulses and/or oilseed in liquid, preferably water. “Allow to swell” preferably excludes “allow to germinate”, such that, in connection with the method according to the invention, “allow to swell” is preferably to be understood as “allow to swell, but not to germinate.” For this purpose, the cereals, pseudo cereals, the pulses and/or oilseeds to be soaked are placed in ample liquid for between 12 and 24 hours. The liquid should be ample because it is absorbed by the cereals, pseudo cereals, the pulses and/or oilseeds. Therefore, the process should be checked occasionally, in order that the soaked cereals, pseudo cereals, the pulses and/or oilseeds do not “dry out.” Allowing to swell can take place at different temperatures and/or at different times. Components (cereals, pseudo cereals, pulses and/or oilseeds) having different swelling behavior can also be swelled separately and subsequently processed mixed together. The conditions for “allowing to swell” are selected such that “allowing to germinate” does not occur.

In connection with the present invention, “wet grinding” is the grinding of cereals, pseudo cereals, pulses and/or oilseed in or under liquid, preferably water.

“Fermentation” is also sometimes referred to herein as “brewing” and vice versa. Both terms refer to the same process. The same applies for the term “fermenting” or “brewing”.

For fermentation in the method according to the invention, a ferment is used. The ferment contains microorganisms which are capable of brewing. Such microorganisms are generally known and also described herein. The ferment for the first fermentation preferably contains those microorganisms which form acid, preferably lactic acid, during brewing. The ferment for the second fermentation preferably contains those microorganisms which form gas, preferably carbon dioxide (CO₂), during brewing.

In order that the first fermentation can take place, a first ferment is preferably introduced into the mushy mass. That is to say that the first ferment is used for the first fermentation described herein. In connection with the present invention, the first fermentation can also be referred to as lacto-fermentation. In order that the second fermentation can take place, a second ferment is preferably introduced into the mushy mass. That is to say that the second ferment is used for the second fermentation described herein.

The first and second ferment are, as described herein, different. The first ferment contains mainly those microorganisms which form acid, preferably lactic acid, during brewing. The second ferment contains mainly those microorganisms which form gas, preferably carbon dioxide (CO₂), during brewing.

The first ferment is added before the first fermentation. The first ferment is preferably mixed with the mushy mass or mixed into the mushy mass.

The second ferment is added before the second fermentation. The second ferment is preferably mixed with the already fermented mushy mass or mixed into the already fermented mushy mass. This can take place for example during filling or transfer of the already fermented mushy mass.

Depending on the taste, traditional ferments, e.g., acidifying cultures, can be used as the first ferment. For diabetics, defined cultures can be used, for example, which largely eliminate short-chain carbohydrates.

In connection with the present invention, the first fermenting and the second fermenting are mutually separated processes. Separated processes in the sense that acid formation takes place during the first fermenting, and gas formation takes place during the second fermenting. Separated processes also because the first fermenting and the second fermenting preferably take place separated from one another in time. Separated processes also because the first fermenting and the second fermenting preferably take place in a manner spatially separated from one another. That is to say that first and second fermenting preferably takes place separated from one another in time and/or space. Preferably, the first fermenting and the second fermenting take place separated from one another in time and space. The spatial separation preferably takes place in that the first fermentation and the second fermentation do not take place in the same vessel, but rather in different vessels. In this case, the mushy mass already fermented after the first fermentation is preferably transferred or filled into another, i.e., new, vessel. The second ferment is then added during the transferring or filling, such that the second fermentation can take place.

In contrast to a fermentation in which both acid and gas formation take place together, e.g., spatially simultaneously and/or at the same time, the fermentation of the method according to the invention is multi-stage, preferably two-stage, i.e., acid formation and gas formation are preferably separated from one another. Thus, during the first fermentation of the method according to the invention, preferably mainly acid formation takes place, preferably only acid formation and no gas formation (CO₂), while during the second fermentation preferably mainly gas formation (CO₂) takes place, preferably only gas formation (CO₂). The separation of the acid formation during the first fermentation and the gas formation during the second fermentation, respectively, is preferably brought about by different ferments. However, as described herein, the separation of acid and gas formation is preferably brought about by means of temporal and/or spatial separation of the first and second fermentation. As described herein, the first and second fermentation can preferably take place separated from one another in space. Preferably, in this case, the once-fermented mass is filled into another vessel or other vessels, in order to then undergo a second fermentation. During this filling or transferring, the second ferment can be added. In this case, the second ferment is preferably mixed into the already fermented mushy mass and/or mixed with the already fermented mushy mass.

The present invention solves the problem of the adjustment of acidification and gas formation during a fermentation, by the separation of said processes into preferably two different fermentations. The acidity level and gas formation can thereby be controlled independently of one another. In the first fermentation, acids are formed by a combination of preferably homofermentative and heterofermentative lactic acid bacteria. A possible gas formation is negligible in this case, since gases of the first fermentation, which may possibly be present, are expelled during mixing-in of the ferment for the second fermentation. Preferably no gas formation (CO₂) occurs during the first fermentation, because no gas-forming microorganisms are used, e.g., no heterofermentative lactic acid bacteria. The gas formation for a foamy consistency of the product takes place in the second fermentation.

The method according to the invention preferably has a step (c″), specifically expelling of gases of the first fermentation during introduction of the second ferment.

Two successive, mutually separated fermentations are preferably required, in order to reproducibly achieve a volume increase as described herein. The volume increase is associated with a defined pore size, pore shape and/or pore distribution. Furthermore, the desired taste and/or the desired texture is also achieved by the preferably two-stage fermentation, as described herein. Moreover, this makes it possible to use automatic filling machines (dispensers, etc.) for an efficient production method without the use of leavens such as baking powder.

For the first fermentation, the ferment preferably contains mainly microorganisms which form acid, preferably lactic acid, during brewing. These are preferably homofermentative lactic acid bacteria and/or heterofermentative lactic acid bacteria, homofermentative lactic acid bacteria being preferred. In a preferred embodiment, the ferment for the first fermentation contains only acid-forming microorganisms, but no gas-forming microorganisms, e.g., it contains no heterofermentative lactic acid bacteria.

For the second fermentation, the ferment preferably contains mainly microorganisms which form gas, preferably carbon dioxide (CO₂), during the brewing. The second ferment preferably contains only gas-forming microorganisms, which are preferably yeasts, e.g., baker's yeast (Saccharomyces ssp., preferably Saccharomyces cerevisiae). While the prior art does not use different ferments, e.g., WO 2017/140796, in the method according to the invention different ferments are used, which precisely lead to acid formation during a first fermentation and to gas formation during a second fermentation. In contrast, in the prior art, acid and gas formation take place simultaneously. This is because a first and second fermentation, as described herein, is not carried out, and in addition because a first and second ferment, as described herein, is not used. In particular, a first ferment which preferably contains only acid-forming microorganisms is not used. This is achieved for example in that, as described herein, preferably no gas-forming (CO₂) microorganisms are contained in the first ferment. In this case, the acid is introduced into the mushy mass during the first fermentation, just as the gas is introduced into the mushy mass during the second fermentation. As described herein, the multi-stage, preferably two-stage, fermentation makes it possible for the mushy mass to be distributed after the first fermentation, e.g., can be portioned, before the second fermentation takes place. In this way, the introduced mass remains present in the mushy mass, as a result of which the volume thereof increases multiple times during the fermenting or during the brewing. The volume multiplication achieves porosity and/or elasticity which would be impossible or possible only to an insufficient extent if the mushy mass were distributed, e.g., portioned, after a one-stage fermentation, i.e., acid and gas formation in one process. In this way, the method according to the invention is advantageous compared with the prior art. It results inter alia in the volume of the then cooked dish being increased compared with dishes from the prior art, as a result of which, for example, more and larger pores are present and/or there is a greater elasticity. The method according to the invention makes it possible for a mushy mass to be formulated which is acidified in a first fermentation and then be distributed, in order for gas to then be introduced into the mushy mass in a second fermentation, which gas ensures volume increase, porosity and/or elasticity of the resulting products, i.e., dishes.

That is to say that the problem of the transfer of a foamy mass from one container, e.g., cooking container, into other vessels, e.g., molds, by means of metering devices, in the case of which the mass collapses and loses its gas content, is solved by the multi-stage, preferably two-stage, fermentation. For example, after the first fermentation (e.g., 8-14 hours), a second ferment, which contains 002-forming microorganisms, is added, and the mushy, acidified mass is filled into molds for example, in which the preferably short second fermentation (e.g., 15-25 minutes), with controlled gas formation, is carried out. In this way, mass production is possible, for which metering devices are essential.

As a result of the multi-stage, preferably two-stage, fermentation, the possible problem of processing mixtures of components (cereals, pseudo cereals, pulses and/or oilseeds) which may have different fermentation behavior (acid/gas formation) is also solved by the present invention. This is because the individual components can pass through the first fermentation separately, under different conditions (time, temperature, type of ferment), and be mixed only for the second fermentation, after the transfer of the individual components into another vessel, e.g., filled into steam molds, in which the second fermentation takes place.

This separation of acidification and gas formation is advantageous for the processing of European components and components which bring about a delay in the rise in blood sugar.

The acid described herein is mainly lactic acid, when a homofermentative lactic acid brewing takes place. In the case of the heterofermentative lactic acid brewing, acetic acid can also result, in addition to lactic acid. Further organic acids can also result during the heterofermentative lactic acid brewing. Very small amounts of alcohol can also result, which, however, evaporates during the cooking process. However, the acid described herein is preferably lactic acid (lactate).

The gas described herein is mainly carbon dioxide (CO₂), which results e.g., during alcohol brewing or also heterofermentative lactic acid brewing.

The possibility that gas also results during the first fermentation of the method according to the invention is not excluded. However, it is preferred that mainly acid, preferably only acid, results during the first fermentation, i.e., preferably no gas (CO₂) results. This is achieved in that the added first ferment preferably contains such microorganisms which form only acid, e.g., by lactic acid brewing, preferably homofermentative lactic acid brewing.

The possibility that acid, e.g., lactic acid and/or acetic acid, also results during the second fermentation of the method according to the invention is not excluded. However, it is preferred that mainly gas, preferably only gas, results during the second fermentation. This is achieved in that the added ferment preferably contains such microorganisms which form only gas, e.g., carry out “yeast brewing”, during which CO₂ results. However, a ferment of the type in which gas-forming and acid-forming microorganisms are present can also be used as the second ferment.

In a preferred embodiment, the first ferment contains microorganisms which form acid and gas (CO₂), but no more than 2 vol. % gas (CO₂), preferably no more than 1.5 vol. % gas (CO₂), e.g., 1 vol. % gas (CO₂), and the second ferment contains microorganisms of the kind that can form acid and gas (CO₂). That is to say that in the first fermentation acid- and gas (CO₂)-forming microorganisms, but no more than 2 vol. % gas (CO₂), preferably no more than 1.5 vol. % gas (CO₂), e.g., 1 vol. % gas (CO₂)-forming microorganisms as described herein, and in the second fermentation gas (CO₂)- and acid-forming microorganisms, are used.

In another preferred embodiment, the first ferment contains microorganisms which form only acid, and the second ferment contains those microorganisms which can form acid and gas (CO₂). That is to say that in the first fermentation only acid-forming microorganisms as described herein, and in the second fermentation gas (CO₂)- and acid-forming microorganisms, are used.

In yet another preferred embodiment, the first ferment contains microorganisms which form only acid, and the second ferment contains only those microorganisms which can form gas (CO₂). That is to say that in the first fermentation only acid-forming microorganisms as described herein, and in the second fermentation only gas (CO₂)-forming microorganisms, are used.

By way of the two-stage fermentation process, the method according to the invention also allows for a more efficient, and thus industrial, production, because, in the case of a one-stage fermentation (simultaneous acid- and gas formation), during dispensing a filling system (dispenser) “drains”, in the truest sense of the word, the gas introduced into the mushy mass during fermentation, and the dispensed “collapsed” mushy mass no longer rises when cooked. In the case of the present invention, the multi-stage fermentation, preferably a two-stage fermentation, causes the mushy mass to preferably double in volume (2-fold volume increase) after the second fermentation, more preferably to increase in volume by two and a half times (2.5-fold volume increase), or even to triple in volume (3-fold volume increase).

The mixing of the ingredients from step (a) of the present production method according to the invention can in principle take place in any desired configuration or combination.

Possible configurations or combinations are:
cereals, pseudo cereals, pulses or oilseeds,
cereals and pseudo cereals or cereals and pulses or cereals and oilseeds or pseudo cereals and pulses or pseudo cereals and oilseeds or pulses and oilseeds,
cereals, pseudo cereals and pulses or pseudo cereals, pulses and oilseeds or cereals, pulses and oilseeds or cereals, pseudo cereals and oilseeds, or
cereals, pseudo cereals, pulses and oilseeds.

In one embodiment of the present invention, at least one cereal and/or at least one pseudo cereal is allowed to swell with at least one pulse and/or at least one oilseed. In this case, the respective ingredients can be allowed to swell either in a common vessel or separately from one another. A person skilled in the art knows typical swelling times for cereals, pseudo cereals, pulses and oilseeds. In the case of the present invention, the swelling time for cereals, pseudo cereals, pulses and/or oilseeds is preferably 6 to 14 hours.

“Cereals” as are used in the method according to the invention or may be contained in the dishes that are or can be produced according to the invention in principle include all cereal types as are known to a person skilled in the art, in particular kernel-containing, usually one-year-old sweet grasses. In particular embodiments of the present invention, cereals, which are left to swell in step (a) of the method according to the invention which is provided here, are for example rice, wheat, spelt, oats, barley, rye, corn, common millet, sorghum, teff, bamboo seeds or triticale, preferably rice, wheat, spelt, oats, barley, rye, corn or common millet. If gluten-free products are to be produced, according to the invention preferably gluten-free cereals are used in step (a), for example corn, rice, common millet or bamboo seeds, preferably corn, rice or common millet. In this connection, “gluten-free” has the same meaning as that specified by the WHO (World Health Organization) and FAO (Food and Agricultural Organization) and describes a content of less than 20 ppm gluten.

“Pseudo cereals” as are used in the method according to the invention or may be contained in the dishes that are or can be produced according to the invention in principle include all pseudo cereal types as are known to a person skilled in the art, in particular kernel-containing, gluten-free plants which do not belong to the sweet grasses but are used similarly to cereals for producing food for humans. On account of the lack of gluten, according to the invention pseudo cereals can also be used in step (a) of the present method, in the event that gluten-free products are intended to be produced (optionally instead of cereals as described above or in addition to gluten-free cereals). In particular embodiments of the present invention, pseudo cereals, which are allowed to swell in step (a) of the method according to the invention that is provided here, are for example buckwheat (for example Fagopyrum esculentum), sesame (for example Sesamum indicum), amaranth, quinoa (for example Chenopodium quinoa) or chia (for example Salvia hispanica).

“Pulses” as are used in the method according to the invention or may be contained in the dishes that are or can be produced according to the invention in principle include all pulses as are known to a person skilled in the art, in particular the (usually air-dried) seeds of legumes. On account of their high protein content, in connection with the present invention pulses can be used in particular when protein-rich products are intended to be produced. In particular embodiments of the present invention, pulses which are allowed to swell in step (a) of the method according to the invention provided here are for example lentils, beans, peas, peanuts, chickpeas, soya or sweet lupins. If pulses are used in the method according to the invention, in one embodiment their portion is at least 20%, 25%, 30% or 40%, preferably at least 25%, particularly preferably at least 30%, based on the dry weight of all ingredients which are then used in the method according to the invention, in particular supplied to step (a) of the method according to the invention at the start of the method.

“Oilseed” or “oilseeds” as are used in the method according to the invention or may be contained in the dishes that are or can be produced according to the invention in principle include all oilseeds as are known to a person skilled in the art, in particular plant seeds which can be extracted for extracting plant oil.

In particular embodiments of the present invention, oilseeds which are allowed to swell in step (a) of the method according to the invention provided here are for example pumpkin seeds, flaxseeds, hempseeds or poppy seeds.

The wet grinding, according to step (b) of the production method according to the invention, of the respective ingredients cereals, pseudo cereals, pulses and/or oilseed (preferably cereals and/or pseudo cereals together with pulses and/or oilseed) as described above can take place separately for each of the mentioned ingredients, or one or more of said ingredients can be wet-ground together. Step (b), i.e., the wet grinding, preferably takes place directly, i.e., immediately after step (a) of allowing to swell.

The wet-ground, mushy mass produced in step (b) of the method according to the invention subsequently undergoes fermenting in a step (c), using acid-forming microorganisms (first ferment). In principle all acid-forming microorganisms suitable for producing foods and fodder can be used here, but preferably lactic acid-forming microorganisms (for example while carrying out homofermentative or heterofermentative lactic acid brewing), for example Lactobacillus sp., L. plantarum, L. fermentum, L. paracasei, L. paralimentarius, L. helveticus, Leuconostoc sp., L. argentinum, L. mesenteroides, L. lactis, or L. rhamnosus. In a preferred embodiment, only acid-forming microorganisms are used, e.g., homofermentative lactic acid bacteria.

Preferably no Leuconostoc ssp. e.g., L. mesenteroides and/or L. plantarum and/or Pediococcus ssp., e.g., Pediococcus pentasaceus is used.

Preferably Leuconostoc ssp. e.g., L. mesenteroides and/or L. plantarum is not added in the first ferment and/or second ferment in colony-forming units (cfu) of at least 10⁵ cfu, 10⁶ cfu, 10⁷ cfu or more per gram (g) of mushy mass (“batter”), i.e., 10⁵ cfu/g batter, 10⁶ cfu/g batter, 10⁷ cfu/g batter or more is preferably not added in the first ferment and/or second ferment or in the first and/or second fermentation, to the mushy mass (=“batter”). Preferably L. plantarum and Leuconostoc ssp. are not used in the first ferment and/or second ferment, or in the first and/or second fermentation in a ratio between 1:1 and 20:1.

If Leuconostoc ssp. e.g., L. mesenteroides and/or L. plantarum is/are used in the first ferment and/or second ferment, then Leuconostoc ssp. e.g., L. mesenteroides and/or L. plantarum is/are preferably added, in the first ferment and/or second ferment, in colony-forming units (cfu) of less than 10⁵ cfu, 10⁴ cfu, 10³ cfu or less per gram (g) of mushy mass (“batter”), i.e., less than 10⁵ cfu/g batter, 10⁴ cfu/g batter, 10³ cfu/g batter or less are added in the first ferment and/or second ferment, or in the first and/or second fermentation, to the mushy mass (=“batter”).

Preferably microorganisms of the family Saccharomycetaceae, in particular Saccharomyces ssp., preferably S. cerevisiae, are contained in the second ferment or used in the second fermentation. The second ferment preferably does not contain any Debaryomyces ssp. yeast, e.g., Debaryomcyes hansenii or other Debaryomyces species. That is to say that preferably microorganisms of the family Saccharomycetaceae, in particular Saccharomyces ssp., preferably S. cerevisiae, exclusively Debaryomyces ssp., e.g., Debaryomyces hansenii or other Debaryomyces species are used in the first ferment or in the first fermentation.

In one embodiment, the fermentation in step (c) of the present method according to the invention is carried out for approximately 8 to 14 hours, preferably at 30° C. or more, particularly preferably 30° C. to 36° C., particularly preferably 30° C. to 34° C., very particularly preferably 30° C. to 32° C. The fermentation is preferably ended at a pH-controlled acidification level which is defined by taste. The amount of the added ferment depends on the selected fermentation time, but is preferably 0.5-3% of the mass to be brewed (wet weight). In this first fermentation step, according to the invention in particular flavorings are introduced and carbohydrates are broken down, such that a desired positive glycemic index is achieved.

In step (c), individual components, i.e., cereals, pseudo cereals, pulses, oilseeds, can be fermented in combination, as described in the following, or fermented separately from one another. In the event of the individual components being ferment separately, they can be mixed with one another after the separate fermentation.

Possible combinations in step (c) are:
cereals and pseudo cereals or cereals and pulses or cereals and oilseeds or pseudo cereals and pulses or pseudo cereals and oilseeds or pulses and oilseeds,
cereals, pseudo cereals and pulses or pseudo cereals, pulses and oilseeds or cereals, pulses and oilseeds or cereals, pseudo cereals and oilseeds, or
cereals, pseudo cereals, pulses and oilseeds.

In connection with the present invention, in the method described and provided here, it is optionally, but alternatively also preferably, possible, in a step (c′), to fill the mass, fermented once in step (c), into another vessel. In a preferred embodiment of the present invention, said new vessel is the vessel which gives the final product (the mass or the (batter) dish) its final shape. This step means that the cooked product later does not have to be transferred again, and the gas introduced in step (d) is largely retained in the product, such that said product maintains a desirable porosity and/or elasticity. In this case, the CO₂-forming microorganisms, which are used according to the invention in step (d) of the present method in the second fermentation step (second ferment), can be added (directly) before the transfer, during the transfer, or (directly) after the transfer into a new vessel according to step (c′), as set out here.

It is the step (c′) which takes account of the multi-stage, preferably two-stage, fermentation, insofar as acid was introduced into the mass during fermentation, before the filling or transfer of the once-fermented mass and gas is introduced in a second fermentation, after the filling or transfer.

In the context of the invention, with the method present and provided here, a second fermenting step (d) is carried out after the first fermenting using acid-forming microorganisms in step (c), or after the filling of the mass, once fermented in this way, into another vessel according to optional step (c′), as described above. According to the invention, a second fermenting of the mushy mass already fermented in step (c) (whether or not it is filled into a new vessel in step (c′)) accordingly takes place in said step (d), using CO₂-forming microorganisms. In this case, in principle all CO₂-forming microorganisms can be used which can be used in the production of foods and fodder. In one embodiment of the present invention, the CO₂-forming microorganism is yeast, for example Saccharomyces cerevisiae. In one embodiment, the fermentation in step (d) of the present method according to the invention is carried out for approximately 15 to 25 minutes, preferably at 30° C. or more, particularly preferably 30° C. to 36° C., more preferably 30° C. to 34° C., most particularly preferably 30° C. to 32° C. The second fermentation is preferably ended by a cooking process (e.g., at 1000° C.), when the mass has achieved approximately a preferably 2-fold volume increase, preferably a 2.5-fold volume increase, or even a 3-fold volume increase. In said second fermentation step, according to the invention in particular gases are introduced which provide the subsequently cooked dish with porosity and elasticity.

The volume increase can preferably be controlled by means of checking by eye or using impedance sensors. Preferably, the volume increase is determined on the basis of the then cooked dish, which preferably is obtained, can be obtained or is obtainable by means of the method according to the invention, by volume displacement. For this purpose, the dish can be packaged water-tight, e.g., by being wrapped in a plastic film, e.g., cling film, and immersed into a measuring beaker filled with water.

In step (d), i.e., during the second fermenting, the already fermented mushy mass preferably doubles in volume, using CO₂-forming microorganisms, more preferably the already fermented mushy mass increases in volume two and a half times, or even triples in volume, using CO₂-forming microorganisms.

A person skilled in the art knows to add CO₂-forming microorganisms to the already fermented mushy mass, before the second fermentation, in oder that the second fermentation can take place. A person skilled in the art preferably mixes the already fermented mushy mass with the added CO₂-forming microorganisms.

If required, the mushy mass(es), fermented twice after step (d), can optionally be mixed in a further step (e).

As already described, it is essential, in the case of the production method according to the present invention, that a two-stage fermentation is carried out (see steps (c) and (d) as described here). Moreover, the two-stage fermentation (separation of the acid and gas formation) allows for the transfer of the acidified mushy mass into a new vessel, in order to carry out the second fermentation there (see optional step (c′) as described here). On the industrial scale, such transfer before the second fermentation is advantageous because, in the case of a one-stage fermentation (simultaneous acid- and gas formation), during dispensing a filling system (dispenser) “drains”, in the truest sense of the word, the gas from the mushy mass, and the dispensed “collapsed,” sunk mushy mass no longer rises when cooked. The separation according to the invention of acid and gas formation is thus advantageous in the production of the product. The optional, but alternatively also preferred, transfer or filling of the product after the first fermentation (c) into a new vessel, which gives the product its final shape, in order to carry out the second fermentation (d) in said vessel, makes it possible to carry out the gas formation without having to transfer the cooked product again. In this way, the introduced gas remains in the product, whereas in the case of a one-stage fermentation the product loses the introduced gas upon transfer into its end product mold. In this way, the end product will lose its porosity and elasticity. This is not the case in the method according to the invention. The advantage of the two-stage fermentation comes into effect in particular in the case of the industrial production by machine, because a filling system, e.g., dispenser, can no longer transfer a gas-containing mushy mass in a standardized manner and in equal amounts by weight into vessels which give the product its final shape, and furthermore said filling system removes in particular the introduced gas from the mushy mass, such that it no longer rises during cooking. That is to say that industrial manufacture by machine is virtually impossible to standardize in the case of a one-stage fermentation, but above all it results in the product no longer rising during cooking and thus not being usable. Overall, the two-stage fermentation brings about two advantages: 1) it helps to provide the product with porosity and/or elasticity, and 2) it allows for a standardized machine-based and industrial production. A further advantage is the controlled acid formation using a desired ferment, which can provide carbohydrates, for example, in such a way that the product finally has a very good glycemic index, which is desirable in particular for diabetics.

Within the context of the present invention, it is furthermore possible to add further additives to the mass, for example spices, salt, cooking oil, sweetener (for example sugar), milk products, nut flour, chopped vegetables (for example root vegetables or tubers, such as potatoes, sweet potatoes, carrots), and/or moisture-increasing agents. The additives are preferably added after the first and/or after the second fermentation.

In one embodiment of the present invention, no artificial leaven is added to the mass to be produced. In this case, “artificial leaven” is generally understood to mean an ingredient which is not an acid-forming or CO₂-forming microorganism, as is used in steps (c) and (d), respectively, of the method according to the invention, but which contributes significantly to acidification and/or gas formation. Examples for such “artificial leavens” comprise inter alia baking powder and baking soda (NaHCO₃), KHCO₃, tartaric acid, Na₂H₂P₂O₇ (disodium pyrophosphate; E450a), or monocalcium phosphate (E341a).

The present invention further relates to a mushy mass, as is obtained, can be obtained or is obtainable according to a method as described above.

In this case, the mushy mass, which preferably is obtained, can be obtained or is obtainable by means of the method according to the invention, preferably always contains a pulse processed according to the invention, i.e., previously swollen, wet-ground and fermented, e.g.
cereals and pulses,
pseudo cereals and pulses,
oilseeds and pulses,
cereals, pseudo cereals and pulses,
pseudo cereals, pulses and oilseeds,
cereals, oilseeds and pulses, or
cereals, pseudo cereals, pulses and oilseeds.
   The portion of the pulses is preferably at least 20%, 25%, 30% or 40%, preferably at least 25%, particularly preferably at least 30%, based on the dry weight of all the ingredients which are used in the method according to the invention, in particular are supplied to step (a) of the method according to the invention at the start of the method, such that, according to the method according to the invention, a mushy mass results which precisely has a portion of the pulses processed according to the invention, based on the dry weight of all ingredients, of at least 20%, 25%, 30% or 40%, preferably at least 25%, particularly preferably at least 30%.

The present invention further comprises a method for producing a dish, wherein first of all the method as described above for producing a mushy mass is carried out, and the mushy mass is subsequently cooked, preferably steamed.

Accordingly, the present invention also relates to a method for producing a dish, comprising the steps described herein and (f) cooking the mushy mass obtained or obtainable according to the method according to the invention described herein.

In more detail, the present invention also relates to a method for producing a dish, comprising the steps described herein
(a) allowing cereals, pseudo cereals, pulses and/or oilseeds to swell;
(b) wet grinding of the swelled cereals, pseudo cereals, the pulses and/or the oilseeds to form a mushy mass;
(c) first fermenting of the mushy mass using acid-forming microorganisms;
(c′) optionally, but alternatively also preferably, filling or transferring the once-fermented mass into another vessel;
(d) second fermenting of the already fermented mushy mass using CO₂-forming microorganisms;
(e) optionally mixing the twice-fermented mushy mass(es); and
(f) cooking the twice-fermented mushy mass(es).

“Allow to swell” preferably excludes “allow to germinate”, such that, in connection with the method according to the invention, “allow to swell” is preferably to be understood as “allow to swell, but not to germinate.”

First and second fermenting preferably takes place separate in time and/or space.

Preferably no intermediate step takes place between the first and second fermenting, i.e., after the first fermenting or before the second fermenting. Preferably, the consistency of the mushy mass is substantially maintained between the first and second fermentation, in particular, the consistency of the mushy mass is maintained between the first and second fermentation. Preferably no liquid-binding foodstuff, such as ground products of cereals, pseudo cereals, legumes, oilseeds or nuts (including real and fake nuts), is added between the first and second fermentation. That is to say that preferably no cereals, pseudo cereals, pulses and/or oilseed, in particular cereals or pseudo cereals or cereals and pseudo cereals in the form of a ground product, e.g., in ground form or as flour, are added between the first and second fermenting.

Likewise, after the second fermenting and before the cooking, the consistency of the mushy mass is substantially maintained, in particular, after the second fermentation and before the cooking, the consistency of the mushy mass is maintained. Preferably no liquid-binding foodstuff, such as ground products of cereals, pseudo cereals, legumes, oilseeds or nuts (including real and fake nuts), is added between the first and second fermentation and before the cooking. That is to say that preferably no cereals, pseudo cereals, pulses and/or oilseed in the form of a ground product, in particular cereals or pseudo cereals or cereals and pseudo cereals in the form of a ground product, e.g., in ground form or as flour, are added after the second fermenting and/or before the cooking.

The cooking takes place in a manner known per se to a person skilled in the art, preferably by steaming, cooking in boiling water, deep-frying, roasting or frying. Cooking in boiling water preferably takes place in closed containers, e.g., tubes, e.g., in a sausage casing.

The present invention further relates to a mushy mass which preferably is obtained, can be obtained or is obtainable by means of the method according to the invention. The mushy mass described herein, which is obtained, can be obtained or is obtainable by means of the method according to the invention, is preferably processed to form a dish for human or animal consumption, preferably human consumption. That is to say that the mushy mass is preferably a food for humans or animals, preferably humans.

In this case, the mushy mass, which preferably is obtained, can be obtained or is obtainable by means of the method according to the invention, preferably always contains a pulse processed according to the invention, i.e., previously swollen, wet-ground and fermented, e.g.
above-mentioned pulses, and cereals processed according to the invention, i.e., previously swelled, wet-ground and fermented,
above-mentioned pulses, and pseudo cereals processed according to the invention, i.e., previously swelled, wet-ground and fermented,
above-mentioned pulses, and oilseeds processed according to the invention, i.e., previously swelled, wet-ground and fermented,
above-mentioned pulses, cereals processed according to the invention, i.e., previously swelled, wet-ground and fermented, and pseudo cereals processed according to the invention, i.e., previously swelled, wet-ground and fermented,
above-mentioned pulses, pseudo cereals processed according to the invention, i.e., previously swelled, wet-ground and fermented, and oilseeds processed according to the invention, i.e., previously swelled, wet-ground and fermented,
above-mentioned pulses, cereals processed according to the invention, i.e., previously swelled, wet-ground and fermented, and oilseeds processed according to the invention, i.e., previously swelled, wet-ground and fermented, or
above-mentioned pulses, cereals processed according to the invention, i.e., previously swelled, wet-ground and fermented, pseudo cereals processed according to the invention, i.e., previously swelled, wet-ground and fermented, and oilseeds processed according to the invention, i.e., previously swelled, wet-ground and fermented.

The portion of the pulses is preferably at least 20%, 25%, 30% or 40%, preferably at least 25%, particularly preferably at least 30%, based on the dry weight of all the ingredients which are used in the method according to the invention, in particular are supplied to step (a) of the method according to the invention at the start of the method, such that, according to the method according to the invention, a mushy mass results which precisely has a portion of the pulses processed according to the invention, based on the dry weight of all ingredients, of at least 20%, 25%, 30% or 40%, preferably at least 25%, particularly preferably at least 30%.

The mushy mass according to the invention, which preferably is obtained, can be obtained or is obtainable by means of the method according to the invention, preferably has acid-forming microorganisms, in particular lactic acid bacteria, and CO₂-forming microorganisms, in particular yeasts. The acid-forming microorganisms, in particular lactic acid bacteria, enter the mushy mass by way of the first fermenting. The CO₂-forming microorganisms, in particular yeasts, enter the mushy mass by way of the second fermenting. Mushy masses, which are known in the prior art, do not comprise both acid-forming microorganisms, in particular lactic acid bacteria, and 002-forming microorganisms, in particular yeasts, e.g., mushy masses as described in WO2017140796.

Preferably the mushy mass contains no Leuconostoc ssp. e.g., L. mesenteroides and/or L. plantarum and/or Pediococcus ssp., e.g., Pediococcus pentasaceus. The mushy mass preferably contains Leuconostoc ssp. e.g., L. mesenteroides and/or L. plantarum added in a quantity of 10⁷ cfu, 10⁶ cfu, 10⁵ cfu or less per gram (g) of mushy mass (“batter”), i.e., the mushy mass contains Leuconostoc ssp. e.g., L. mesenteroides and/or L. plantarum in a quantity of less than 10⁷ cfu/g batter, 10⁶ cfu/g batter, 10⁵ cfu/g batter or less.

Preferably, the mushy mass does not contain any Debaryomyces ssp. yeasts, e.g., Debaryomyces hansenii.

The present invention further comprises a dish as is obtainable, is obtained, or can be obtained according to the above-described method for producing a dish. As described here, such a dish according to the invention has particular advantages with respect to the porosity, elasticity and/or the skin structure (smooth skin).

A dish of the present invention, which preferably is obtainable, is obtained, or can be obtained by means of the method according to the invention, preferably has a smooth skin. In this case, the dish which preferably is obtained, can be obtained or is obtainable by means of the method according to the invention preferably always contains a pulse processed according to the invention, i.e., previously swollen, wet-ground and fermented, e.g.
above-mentioned pulses, and cereals processed according to the invention, i.e., previously swelled, wet-ground and fermented,
above-mentioned pulses, and pseudo cereals processed according to the invention, i.e., previously swelled, wet-ground and fermented,
above-mentioned pulses, and oilseeds processed according to the invention, i.e., previously swelled, wet-ground and fermented,
above-mentioned pulses, cereals processed according to the invention, i.e., previously swelled, wet-ground and fermented, and pseudo cereals processed according to the invention, i.e., previously swelled, wet-ground and fermented,
above-mentioned pulses, pseudo cereals processed according to the invention, i.e., previously swelled, wet-ground and fermented, and oilseeds processed according to the invention, i.e., previously swelled, wet-ground and fermented,
above-mentioned pulses, cereals processed according to the invention, i.e., previously swelled, wet-ground and fermented, and oilseeds processed according to the invention, i.e., previously swelled, wet-ground and fermented, or
above-mentioned pulses, cereals processed according to the invention, i.e., previously swelled, wet-ground and fermented, pseudo cereals processed according to the invention, i.e., previously swelled, wet-ground and fermented, and oilseeds processed according to the invention, i.e., previously swelled, wet-ground and fermented.
   The portion of the pulses is preferably at least 20%, 25%, 30% or 40%, preferably at least 25%, particularly preferably at least 30%, based on the dry weight of all the ingredients which are used in the method according to the invention, in particular are supplied to step (a) of the method according to the invention at the start of the method, such that, according to the method according to the invention, a mushy mass results which precisely has a portion of the pulses processed according to the invention, based on the dry weight of all ingredients, of at least 20%, 25%, 30% or 40%, preferably at least 25%, particularly preferably at least 30%.
   A dish of the present invention, which preferably is obtainable, is obtained, or can be obtained by means of the method according to the invention, preferably has gas pores which are visible to the naked eye. The size of the gas pores results from the volume of the mushy mass being preferably doubled, more preferably increased two and a half-fold, or even increased three-fold, during the second fermenting. Thus, in one embodiment it is possible to see gas pores with the naked eye, in the case of the dishes which are produced or can be produced according to the invention. Said gas pores can be seen with the naked eye upon cutting and/or separation.

A dish of the present invention, which preferably is obtainable, is obtained or can be obtained by means of the method according to the invention is two to three times larger, most preferably two and a half times larger, than known dishes, with respect to volume. The volume of the mushy mass according to the invention, or the dish according to the invention which preferably results therefrom, both of which are described herein, is preferably determined directly after cooking of the mushy (gassed) mass, which becomes the dish described herein during cooking, preferably as described herein by volume displacement.

A dish of the present invention, which preferably is obtainable, is obtained or can be obtained by means of the method according to the invention, preferably contains dead and/or living acid-forming microorganisms, in particular lactic acid bacteria, and dead and/or living CO₂-microorganisms, in particular yeasts. The acid-forming microorganisms, in particular lactic acid bacteria, enter the mushy mass, which is then cooked, by way of the first fermenting. The CO₂-forming microorganisms, in particular yeasts, enter the mushy mass, which is then cooked, by way of the second fermenting. On account of the CO₂-forming microorganisms, in particular yeasts, in particular S. cerevisiae, introduced during the second fermenting, the dish according to the invention preferably has a subtle yeast flavor.

A dish of the present invention, which preferably is obtainable, is obtained, or can be obtained by means of the method according to the invention, preferably has a high degree of elasticity. In this case, the elasticity can be objectively measured by means of methods known to a person skilled in the art, for example by means of a texture profile analysis (TPA). In this case, it is possible for example to measure the crumb hardness (N) and crumb elasticity (%), according to the AACC (American Association of Cereals Chemists) Method 74-09, as is also described in WO 2011/151331, pages 9 and 10.

A preferred dish of the present invention, which preferably is obtainable, is obtained or can be obtained by means of the method according to the invention, has preferably undergone a 2-fold volume increase, more preferably a 2.5-fold to 3-fold volume increase, preferably a 2.5-fold volume increase following the fermenting and cooking, preferably has a subtle yeast flavor, and preferably also contains, in addition to dead and/or living acid-forming microorganisms, preferably lactic acid bacteria, living and/or dead CO₂-microorganisms, preferably yeast, e.g., S. cerevisiae. Dishes as described in WO2017140796 have at most a 1.5-fold volume increase after cooking, such that said dishes also have a lower porosity than dishes of the present invention.

A dish of the present invention, which preferably is obtainable, is obtained or can be obtained by means of the method according to the invention, may preferably contain no Leuconostoc ssp. e.g., L. mesenteroides and/or L. plantarum and/or Pediococcus ssp., e.g., Pediococcus pentasaceus. A dish of the present invention, which preferably is obtainable, is obtained or can be obtained by means of the method according to the invention, preferably contains Leuconostoc ssp. e.g., L. mesenteroides and/or L. plantarum in a quantity of less than 10⁷ cfu, 10⁶ cfu, 10⁵ cfu or less per gram (g) of mushy mass (“batter”) from which it can be produced, is produced or is producible, i.e., the dish contains Leuconostoc ssp. e.g., L. mesenteroides and/or L. plantarum in a quantity of less than 10⁷ cfu/g batter, 10⁶ cfu/g batter, 10⁵ cfu/g batter or less, from which it can be produced, is produced or is producible.

The dish of the present invention, which preferably is obtainable, is obtained, or can be obtained by means of the method according to the invention, preferably contains no living and/or dead Debaryomyces ssp. yeasts, e.g., Debaryomyces hansenii.

A preferred embodiment of the method according to the invention or of the dish obtainable thereby, a dish which can be obtained or is obtained thereby, is as follows:

The range of vegetarian and vegan dishes is very limited. Therefore, a dish is intended to be produced, preferably by means of the method according to the invention described herein, which dish is ideally characterized by the following:
The high starch portion does not lead to a rapid increase in the blood sugar level and a subsequent sharp drop thereof, which can lead to tiredness. In the case of diabetics, this makes the blood sugar level substantially easier to control, as a result of which the number of insulin injections per day can be reduced.
Healthy and healing effect on the microbiome of the intestine due to the high portion of prebiotics/fiber, and thus particularly suitable for people with a sensitive stomach and intestine.
Suitable as a full, hot, protein-rich, vitamin-rich and healthy meal.
Rich in vitamins, in particular vitamin B complex and omega 3 fatty acids.
low-pollution
Suitable for system catering/traditional catering/franchise/food trucks

In the following, a preferred dish which is obtainable, is obtained or can be obtained by means of the method according to the invention will be described.

The basic contents of the novel, preferably vegetarian or vegan, dish consists of the individual components mentioned herein, preferably of two main components, specifically cereals/pseudo cereals, and legumes/oilseeds. High protein contents are achieved in this way.

The dishes can preferably contain salt, sugar or other sweeteners, spices, cooking oil, milk products, and flour of any nuts, for flavor rounding.

Preferably root vegetables, tubers such as potatoes/sweet potatoes can be added in small percentages, and moisture-increasing agents in a very small amount.

The innovation results from the combination of the production method steps, as described herein, together with the composition of the products, which ideally lead to positive effects with respect to diet and health.

This combination of the production processes ideally optimizes the reduction of bitter substances, short-chain carbohydrates and undesired substances (e.g., in particular arsenic and mercury in rice, and/or unwholesome secondary plant metabolites in legumes). For corn, this method allows for nixtamalization that is integrated into the production process, by means of which the niacin content of the corn (vitamin B3) is made available for human nutrition. The result is a product which is extremely gentle on the stomach and intestine, and supports the microbiome of the digestive system.

A list, by way of example, of preferred components for the dish according to the invention is:
Cereal components: (Poaceae): rice, wheat, spelt, oats, barley, rye, corn, common millet (Paniceae), sorghum, teff (Eragrostis tef), triticale (hybrid of wheat and rye)
Pseudo cereal components: buckwheat (Fagopyrum esculentum), sesame (Sesamum indicum), amaranth (Amarantus sp.), quinoa (Chenopodium quinoa), chia (Salvia hispanica)
Pulse components (legumes): lentils, beans, peas, peanuts, chickpeas, soya, sweet lupins.
Oilseed components: pumpkin seeds, flaxseeds, hempseeds, poppy seeds

Preferred embodiments, by way of example, of the method according to the invention:

### 1. Embodiment 1

The legumes used, as well as rice and corn, are wet-ground after swelling in water. Further additives can be wet-ground or dry-ground.
Preferably a combination of a cereal/pseudo cereal component with a legume component and/or oilseed component is always used (see:“list, by way of example, of preferred components for the dish according to the invention”).
These two main components can be supplemented by small percentages of further components. A mush-like mass is produced by way of a multi-stage, preferably two-stage, fermentation.
This mass is steam-cooked in any molds.

### 2. Embodiment 2, Preferred Over Embodiment 1

Spices, salt, sugar, milk products, flours of any nuts, vegetables, grated potatoes/sweet potatoes, and very small amounts of moisture-increasing agents can be mixed in as further additives.

### 3. Embodiment 3 (Specifically Further Processing), Preferred Over Embodiment 1 and 2

The starch portion of the cooked products can be largely converted into retrograded starch, which is absorbed more slowly by the intestine, by temperature control at 0° C.+/−7° C.

### 4. Embodiment 4, Preferred Over Embodiment 1

Combination of the production steps and ingredients set out in embodiment 1.

Specific preferred embodiment, by way of example, of the invention:

Rice, corn and legumes are swelled in water before processing, the swelling water being discarded. Subsequently, the swelled components are wet-ground. The selected mixture is fermented to form a mush-like mass by means of multi-stage, preferably two-stage, fermentation using different ferments, preferably a first and second ferment, as described herein. The mush-like mass is steam-cooked in different molds. The starch is in large part converted into retrograde starch by temperature control of the cooked products at suitable temperatures.
The present invention can also be described by the following subjects:
Subject matter 1
1. Method for producing a mushy mass, comprising
(a) allowing cereals, pseudo cereals, pulses and/or oilseeds to swell;
(b) wet grinding of the swelled cereals, pseudo cereals, the pulses and/or the oilseeds to form a mushy mass;
(c) first fermenting of the mushy mass using acid-forming microorganisms; and
(d) second fermenting of the already fermented mushy mass using CO₂-forming microorganisms,
wherein first and second fermenting takes place separated from one another in time and/or space.
Subject matter 2:
2. Method according to subject matter 1, comprising
(c′) filling or transferring the once-fermented mass into another vessel.
Subject matter 3:
3. Method according to either subject matter 1 or subject matter 2, comprising
(e) optionally mixing the twice-fermented mushy mass(es).
Subject matter 4:
4. Method according to any of the preceding subjects, further comprising adding spices, salt, cooking oil, sweetener, milk products, nut flour, chopped vegetables, and/or moisture-increasing agents.
Subject matter 5:
5. Method according to any of the preceding subjects, wherein the first fermenting is 8 to 14 hours.

Subject matter 6:

6. Method according to any of the preceding subjects, wherein the first fermenting is 15 to 25 minutes.
Subject matter 7:
7. Method according to any of the preceding subjects, wherein the cereal is rice, wheat, spelt, oat, barley, rye, maize or common millet.
Subject matter 8:
8. Method according to any of the preceding subjects, wherein the pseudo cereal is buckwheat, sesame, amaranth, quinoa or chia.
Subject matter 9:
9. Method according to any of the preceding subjects, wherein the pulse is lentils, beans, peas, peanuts, chickpeas, soya or sweet lupins.
Subject matter 10:
10. Method according to any of the preceding subjects, wherein the oilseed is pumpkin seeds, flaxseed, hempseed or poppy seeds.
Subject matter 11:
11. Method according to any of the preceding subjects, wherein the portion of the pulses is at least 30%.
10 Subject matter 12:
12. Method according to any of the preceding subjects, wherein an artificial leaven, for example baking powder, is not added in any step.
Subject matter 13:
13. Mushy mass obtained or obtainable according to the method according to any of subjects 1 to 12.
Subject matter 14:
14. Method for producing a dish, comprising
(f) cooking the mushy mass according to subject matter 13.
Subject matter 15.
15. Dish, obtained or obtainable according to the method according to subject matter 14.

In connection with the present invention, singular forms such as “a” or “an” in each case also include the plural forms, and vice versa, unless otherwise specified at the relevant point.

The term “and/or”, as used herein, in each case includes the meanings “and”, “or”, as well as “all or each individual combination of two or more elements of the components grouped by the term”.

In this case, the term “comprising” or “including” also comprises the more restrictive term “consisting of”, unless otherwise specified at the relevant point.

The present invention is generally not limited to particular embodiments, examples, protocols or the like, as described herein. Rather, such embodiments, examples, protocols or the like serve to illustrate the invention but without restricting it thereto.

All the publications cited here are hereby incorporated in their entirety as part of the description. If there are inconsistencies between the content of the cited publications and the present descriptions of the invention, the present description takes precedence.

### EXAMPLES

### Example 1: Corn Dish

### Ingredients:

| | | |
|---|---|---|
| 2000 g corn kernels | 4.6 l water | 80 g salt(85) |
| 1600 g split black lentils | 300 g yogurt | 30 g leaven |
| 400 g rice | 300 g peanut oil | 100 g yeast + 15 g |
| | | sugar + 100 ml H₂O |

(Cereals including corn: 60%; legumes 40% based on the dry weight)

### Example 2: Pumpkin Seed Dish

### Ingredients:

| | | |
|---|---|---|
| 1.8 kg pumpkin seeds | 5.15 l water | 120 g salt |
| 900 g split black lentils | 450 g yogurt | 45 g leaven |
| 1.8 kg rice | 150 g pumpkin seed oil | 150 g yeast + 22.5 g |
| | | sugar + 100 ml H₂O |

(Cereals: 40%; legumes + oilseeds 60% based on the dry weight)

### Preparation for Example 1 and Example 2:

a) Allow to swell
Rice and corn or pumpkin seeds are swelled together in 3 times the amount of water for 10-12 hours at 20-25° C. Black lentils are swelled separately for 6-8 hours at 20-25° C. The excess water is discarded.
b) Wet grinding
Rice is ground to a paste together with corn or pumpkin seeds. Black lentils are ground separately.

### c) Fermentation 1

Yogurt, salt, peanut oil or pumpkin seed oil and leaven are added proportionately to rice together with corn or pumpkin seeds, and black lentils separately. Water is added proportionately, such that the total amount of water including the water absorbed during the swelling reaches the specified values. The mass is then stirred thoroughly.
Rice together with corn or pumpkin seeds is fermented for 10-12 hours at 30-32° C.
The black lentil mass is fermented for 6-8 hours.

### d) Fermentation 2

Black lentils and the yeast dissolved in sugar water is added to the respective mass.
Subsequently, the mass is immediately metered into the vessels for cooking and fermented for 15-25 minutes at 30-32° C. in order to increase in volume.

### e) Cooking

The filled mass is subsequently cooked.

### Example 3: Pumpkin Seed “Viffffs”

300 g flour, all specifications in dry weight (fresh weight 400 g)

| | | |
|---|---|---|
| rice | 120 g | (40%) |
| lentils | 60 g | (20%) |
| pumpkin seeds | 120 g | (40%) |

(Cereals: 40%; legumes + oilseeds 60%)

### Example 4: Corn “Viffffs”

400 g flour (fresh weight 400 g)

| | |
|---|---|
| corn | 200 g (50%) |
| rice | 100 g (25%) |
| lentils | 100 g (25%) |

(Cereals including corn: 75%; legumes + oilseeds 25%)

### Example 5: Rice “VIFFFFs”

270 g flour
200 g rice
70 g lentils (black)
(Cereals: 74%; legumes 26%)

1. Method for producing a mushy mass, comprising
(a) allowing cereals, pseudo cereals, pulses and/or oilseeds to swell but not to germinate;
(b) wet grinding of the swelled cereals, pseudo cereals, the pulses and/or the oilseeds to form a mushy mass;
(c) first fermenting of the mushy mass using acid-forming microorganisms; and
(d) second fermenting of the already fermented mushy mass using CO₂-forming microorganisms,
wherein first and second fermenting takes place separated from one another in time and/or space, and wherein the consistency of the mushy mass is substantially maintained between the first and second fermentation.

2. Method according to claim 1, comprising
(c′) filling or transferring the once-fermented mass into another vessel.

3. Method according to either claim 1 or claim 2, comprising
(e) optionally mixing the twice-fermented mushy mass(es).

4. Method according to any of the preceding claims, further comprising
adding spices, salt, cooking oil, sweetener, milk products, nut flour, chopped vegetables, and/or moisture-increasing agents.

5. Method according to any of the preceding claims, wherein the first fermenting is 8 to 14 hours.

6. Method according to any of the preceding claims, wherein the first fermenting is 15 to 25 minutes.

7. Method according to any of the preceding claims, wherein the cereal is rice, wheat, spelt, oat, barley, rye, maize or common millet.

8. Method according to any of the preceding claims, wherein the pseudo cereal is buckwheat, sesame, amaranth, quinoa or chia.

9. Method according to any of the preceding claims, wherein the pulse is lentils, beans, peas, peanuts, chickpeas, soya or sweet lupins.

10. Method according to any of the preceding claims, wherein the oilseed is pumpkin seeds, flaxseed, hempseed or poppy seeds.

11. Method according to any of the preceding claims, wherein the portion of the pulses is at least 25%.

12. Method according to any of the preceding claims, wherein an artificial leaven, for example baking powder, is not added in any step.

13. Method for producing a dish, comprising
(f) cooking the mushy mass obtained or obtainable according to the method according to any of claims 1 to 12.

14. Mushy mass obtained or obtainable according to the method according to any of claims 1 to 12, wherein the mushy mass in any case contains pulses processed according the method of claims 1 to 12.

15. Mushy mass according to claim 14, wherein the mushy mass
in any case contains pulses and cereals processed according to the method of the preceding claims,
in any case contains pulses and pseudo cereals processed according to the method of the preceding claims,
in any case contains pulses and oilseeds processed according to the method of the preceding claims,
in any case contains pulses, cereals and pseudo cereals processed according to the method of the preceding claims,
in any case contains pulses, pseudo cereals and oilseeds processed according to the method of the preceding claims,
in any case contains pulses, cereals and oilseeds processed according to the method of the preceding claims,
in any case contains pulses, cereals, pseudo cereals and oilseeds processed according to the method of the preceding claims.

16. Method for producing a dish, comprising
(f) cooking the mushy mass according to either claim 14 or claim 15.

17. Dish, obtained or obtainable according to the method according to claim 16.
